(19) United States
(12) Patent Application Publication
(10) Pub. No.: US 2002/0183102 A1
(43) Pub. Date: Dec. 5, 2002

(54) RBDS method and device for processing promotional opportunities

(76) Inventors: James G. Withers, Chesterfield, MO (US); Alan G. Maltagliati, St. Louis, MO (US)

Correspondence Address: Greensfelder, Hemker & Gale, P.C., Intellectual Property Practice Group, Suite 2000, 10 South Broadway, St. Louis, MO, 63102, US

(21) Appl. No.: 10/126,770

(22) Filed: Apr. 19, 2002

Related U.S. Application Data
(60) Provisional application No. 60/285,161, filed on Apr. 21, 2001.

(51) Int. Cl. H04B 1/38

(52) U.S. Cl. 455/575; 455/466; 455/66; 455/186.1

(57) ABSTRACT

A system is described for deriving benefits from the reception and processing of auxiliary data by a hand-held device 12, such as a smart card, personal digital assistant (PDA), or mobile phone.

The user receives benefits such as promotional opportunities resulting from the reception of the auxiliary data via use of the radio broadcast data system (RBDS) protocol. Such opportunities are expressed on visual display 20, which may include a series of lights 20a, 20b, 20c, and/or 20d, or an LCD 44. The lights and LCD provide promotional opportunities which may be redeemable at conventional stores or via the Internet. Hand-held devices 12 are outfitted with a PCMCIA interface 70 or wireless Internet access to obtain such promotional activities on the Internet.

### CROSS-REFERENCE TO RELATED APPLICATIONS

This application is based upon United States Provisional Patent Application titled “RBDS Method and Device for Processing Opportunities”, Serial No. 60/285,161, Filed Apr. 21, 2001 by James G. Withers and Alan G. Maltagliati, which is herein incorporated by reference and continued preservation of which is requested.

### BACKGROUND OF THE INVENTION

The present invention relates to interactive hand-held devices, and more particularly to a method and apparatus for receiving and decoding modulated signals for use by hand-held devices, and providing benefits to users of the device from the reception of the signals.

Users of the hand-held device selectively receive modulated signals for purposes including enjoyment, promotion, transfer of information, data collection, commercial verification, security, education, and transactions or verifications at points of sale, as well as other commercial, personal, entertainment, or amusement purposes collectively referred to herein as “promotional opportunities.” Data is sent to the hand-held device by electrical means utilizing the RBDS protocol. Data may be received by utilizing by use of FM, AM, and/or other radio frequency reception means. Use of the hand-held device may allow users to receive, process, and/or store promotional opportunities.

U.S. Pat. No. 4,807,031 Broughton et al. (“Broughton”) titled “Interactive Video Method and Apparatus” relates generally to in-band video broadcasting of commands and other encoded information to interactive devices. The invention described therein relates generally to interactive educational and entertainment systems, and is described in one embodiment in the context of television program control of toys located where there is a television receiver, as within a residence.

To encode control data capable of providing a benefit to a user, Broughton discloses a novel method of luminance or chrominance modulation of a video signal that creates a composite video signal, whereby modulating the video signal creates control data. The novel modulation method alternately raises and lowers the luminance/chrominance of adjacent horizontal scan lines to create a video subcarrier that contains the control data.

Under Broughton, the video signal is not being replaced with other data, nor is the data being added as a separate signal along with the video signal, rather, the video signal itself is modulated to subsequently create the control data. Therefore, the control data is a part of, or contained within, the video signal. The encoding method also includes preview and remove circuitry to ensure suitability or the presence of data encoding and removal of data encoding, respectively.

The control data is transmitted either by television broadcast means, or by pre-recorded video players that are connected to a video display. The control data is then received by the video display where a video field of the video display is modulated by control data. The control data is then detected with either opto-electronic or radio frequency (RF) detection means that discriminate the program material from the control data. The detected control data is further reproduced such that the control data can be used with an interactive device.

A practical example of a device as described above is the commercially-sold hand-held game device for receiving and detecting such control data called the “Wheel of Fortune” interactive television (ITV) Play-Along Game, intended to be used while viewing a television program presentation of the famous television show of the same name. The device, produced under license by the assignee of Broughton, was a palm-sized device that included a photosensor within its case to receive video signals. The device, upon receiving composite video signals, then discriminated the control data from the video program material and caused a liquid crystal display (LCD) on the face panel of the toy to present portions of a word puzzle. Thereby users of the device may play the game along with a contestant, or play in response to a videotaped presentation of the game. The “Wheel of Fortune” ITV game together with its hand-held control device including keyboard was commercially available in 1988.

Improvements on the method of modulation described in Broughton are described in U.S. Pat. No. 6,094,228 to Ciardullo et al. and U.S. Pat. No. 6,229,572 to Ciardullo et al. (referred to collectively hereinafter as “Ciardullo”). Both patents describe improved methods of modulation wherein control data is inserted on the visual portion of a video signal by changing the luminance of paired lines in opposite directions, thus allowing larger amounts of data to be modulated in a signal. Broughton and Ciardullo are incorporated by reference herein.

Efforts by others to provide hand-held devices capable of receiving transmission of modulated data from a video display are represented by U.S. Pat. Nos. 5,594,493; 5,761,601; 5,767,896, 5,907,350, and 5,953,047. Of these, U.S. Pat. No. 5,907,350 discloses a method for storing data on a so-called smart card, which is contended to receive, decode and store encoded data signals comprising redeemable coupons said to be embedded within television segments and transmitted along with normal television segments. The device of U.S. Pat. No. 5,907,350 is a hand-held unit that receives luminance signals from the television display in accordance with the principles of Broughton. The received video signals are decoded and stored within the card for future use. The card's LCD readout enables Universal Price Codes (UPC) corresponding to the stored data. A scanner reads the UPC codes at a redemption site, and the stored coupon is then erased from a memory of the card. A microprocessor channels the decoding and storage aspects, and a keypad allows use and input.

The term “smart card” as used in the above patents, connotes a hand-held, portable device, not conceptually different from the above-mentioned “Wheel of Fortune” ITV game device. However, the term does not only apply to those patents.

As a generic term, “smart card” gradually has come to mean a card that looks like a credit card but includes a microchip or microprocessor embedded or incorporated into the card. The smart card may be referred to as a “fingerheld” computer, typically including a data storage media ranging from less than a kilobyte up to a megabyte (if not more), and are said to have originated in France. Ognibene, P. J., “Card Smarts,” Technology Decisions (July, 1999). Smart cards may, according to a line of reference, also be called “chip cards.”

Prior efforts by the assignees of the present patent application include U.S. Utility patent application titled “Interactive Optical Cards and Other Hand-Held Devices with Increased Connectivity”, Ser. No. 09/489,373, Filed Jan. 21, 2000 by Edward J. Koplar and Daniel A. Ciardullo (“Koplar I”), which is incorporated by reference herein. Koplar I relates to various methods and apparatuses for use with promotion opportunities, such as interactive advertising and gaming. Koplar I describes various methods for receiving and providing data to handheld devices, as well as apparatuses for use with promotional opportunities and methods of using the same.

Another patent application by the assignees of the present is U.S. Utility patent application titled “Universal Methods and Device for Hand-Held Promotional Opportunities”, Ser. No. 09/829,223, Filed Apr. 9, 2001 by Edward J. Koplar, Daniel A. Ciardullo, James G. Withers and Christopher E. Chupp (“Koplar II”), which is incorporated by reference herein. Koplar II describes additional methods for receiving and providing data to handheld devices, as well as apparatuses for use with promotional opportunities and methods of using the same.

For purposes of the present invention, the term “handheld device” means an interactive device of portable character, preferably of hand-held type that may be carried in the palm by a user, between fingers of the user, or is otherwise intended to be easily grasped and handled manually by the user.

While the hand-held device of the present invention may be in the form of a smart card, it may also be in the form of other types of hand-held devices such as mobile phones. Recently, mobile phones have become equipped with increased capacity to store and process information, and many phones now offer limited network or Internet access. Industry experts estimate that by 2002, more than 100 million mobile phones will have Internet access in some fashion and that by 2003, more than 1 billion mobile phones will be in use worldwide. Mobile phones, with or without Internet access, become powerful tools when appropriately configured to receive auxiliary data.

The personal digital assistant (PDA) is another form of hand-held device that may provide its users with promotional opportunities under the present invention. The most popular manufacturer of PDAs, Palm Computing, introduced its first PDA called the “Palm Pilot” in 1996. The latest version of the Palm Pilot, Palm VII, was introduced in 1999 and was the first PDA to include wireless Internet access without the need of a peripheral device such as a modem.

PDAs and mobile phones, while capable of providing users with Internet access, as of the time of this invention have limited capabilities and functionality as a result of slow data transfer rates. It is desirable to provide users of these hand-held devices and similar devices such as smart cards with hand-held devices that are compact in size yet rich in content that encourage users to participate in various promotional opportunities without having prolonged delays to receive and process information. Smart cards, mobile phones, PDAs, and similar hand-held devices are all capable of participating with the promotional opportunities described in the present invention and are collectively referred to herein as “handheld devices” of the present invention.

The term “sponsor” is used herein in its broadest possible sense, and may include without limitation entities that issue hand-held devices and entities that accept them or provide redemption services for users of the devices. Sponsors may also include health care and medical institutions and other service or eleemosynary organizations.

The term “computer” is used herein in its broadest possible sense, and may include without limitation a laptop or personal computer, mobile phone, personal digital assistant, or other computer-like device.

### SUMMARY OF THE INVENTION

Among the several objects, features and advantages of the invention may be noted the provision of interactive hand-held devices for carrying out novel and commercially advantageous signaling, information-transferring, and value-indicating methods. The hand-held devices of the present invention are portable devices such as smart cards, mobile phones, and PDAs, which contain means to receive auxiliary data by use of the RBDS protocol. The hand-held devices, to provide some of the promotional opportunities described herein and in Koplar I and Koplar II, preferably have means to connect to the Internet, which may be referred to herein interchangeably as “network access”, “wireless access”, “Internet access” or “wireless Internet”.

The hand-held devices, may additionally utilize the modulation and decoding methods described in Broughton and Ciardullo for transmission of auxiliary data from a source via electrical and/or optical means, as well as alternatively by other known methods of modulation in the art including through the use of the vertical-blanking interval (VBI), audio subcarrier, electromagnetic subcarrier, and RF detection of video decoding. However, it is preferable to use the radio broadcast data system (RBDS) modulation and decoding method as further described in this application.

Signals are received, detected, and reproduced by the hand-held devices for various promotional opportunities including: enjoyment; promotion; coupon or prize validation; advertising by sponsors; advertising verification and polling; transfer of information; data collection; commercial verification; security and access; education; game playing; transactions, verifications, or redemption by sponsoring entities or related commercial locations at points of sale including the Internet; other commercial and non-commercial purposes.

The following are merely illustrative of some of the advantages and objects which the new system provides: television advertising response determination; interactive advertising and promotions; attraction of viewers' attention; effectively increase consumer awareness and retention of commercial advertising, messages, announcements, promotions, and specific products and services; increased customer differentiation of products and services; stimulation of viewers to watch commercials; increase of store traffic in response to commercial messages; fostering of consumer loyalty; enhancement of viewer involvement in program content, including commercials; enhancement of viewer retention of the content of commercial and other messages; enhancement of the value of commercial messages; increased product/service sales; saving of advertising costs; acceleration of response time of customers following delivery of commercial messages; verification of contests and awards; enhancement of viewer retention of the related website domain names; reduction of barriers related to e-commerce opportunities; additional and sometimes instant rewards and information obtainable via the Internet. The uses and advantages are more fully developed in the following description.

When auxiliary data is reproduced by use by the handheld device, various signals, indications, display readouts, or other interactive events provide the user with a benefit according to content of the auxiliary data. The various interactive events described in Koplar I and Koplar II, incorporated by reference herein, are usable interchangeably by and in conjunction with the hand-held device and methods of use with the present invention. The interchangeability includes selective use of the features of the present invention, along with selective use of any of the various apparatuses and methods of Koplar I and Koplar II.

The enclosure of the hand-held device is typically in the shape and form of smart cards, palm devices, or mobile phones. Additionally, other hand-manipulable devices of a similar size and nature that are capable of receiving and processing auxiliary data as described herein are also within the scope of the present invention. Such hand-manipulable devices include stuffed animals or toys, snapshot-type cameras, replica sports helmets, scaled racing cars, or replica baseball bats.

Radio Broadcast Data Service (RBDS; known as RDS outside of the United States) was recently authorized by the FCC as a method for sending text to FM radio receivers. Envisioned uses of RBDS include call letter/slogan display info, song titles/lyrics, and traffic and weather info. Car radios, in particular, were designed so that text received using RBDS could be displayed on the LCD tuning window of a car radio, alternating with, or taking the place of, the normal frequency readout. The speed of the system (throughput) is fairly slow at between 1200 to 2400 bps. To date, the system is underutilized, with no practical uses having been identified.

Radio salespeople have long struggled to answer a basic objection from advertisers when comparing radio advertising to print; namely, the inability of radio to offer “hard copy” coupons. Advertisers have always viewed couponing as a surefire way to gauge the effectiveness of advertising, since there is a paper trail (the redeemed coupons) from a print advertisement that does not exist with a radio advertisement. Thus, it is desirable to provide a practical means of radio couponing by which “off of the air” promotional opportunities are received directly on a hand-held device.

Various other apparatuses and methods of the present invention are set forth in the following description and claims. Similarly, other objects and features will be apparent or are pointed out more particular herein below.

### BRIEF DESCRIPTION OF THE DRAWINGS

FIG. 1 is a perspective external view of an embodiment of an interactive hand-held device in accordance with and embodying the present invention.

FIG. 2 is a perspective external view of another embodiment of an interactive hand-held device of the invention.

FIG. 3 is a schematic diagram of circuitry that may be used to provide various embodiments having circuit features evident in this diagram.

FIG. 4 is a block diagram of the method of radio frequency detection using RBDS by a hand-held device.

FIG. 5 is a block diagram of the method of encoding information on radio signals using a computer with RBDS encoder.

FIG. 6 is a another block diagram of the method of radio frequency detection using RBDS by a hand-held device.

Corresponding reference characters identify corresponding elements throughout the several views of the drawings.

### DESCRIPTION OF INVENTIVE EMBODIMENTS

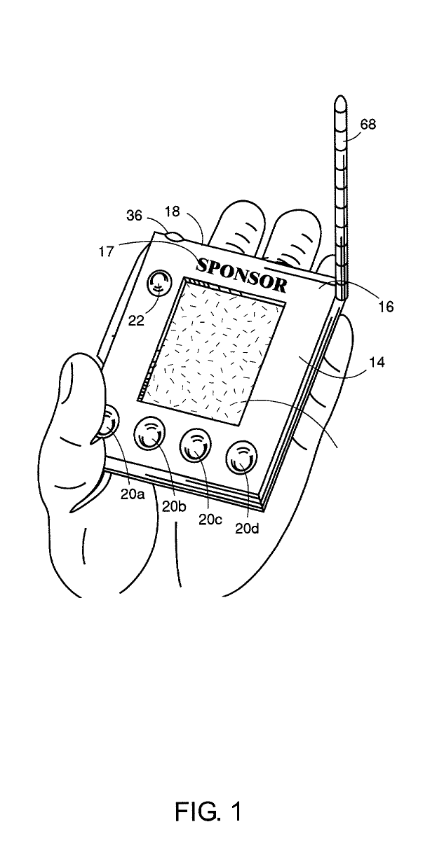

Hand-held device 12 is depicted in FIG. 1 as a PDA and shown in a manner in which it may be held and used. Handheld device 12 may include a PDA-sized housing 14 that encloses various circuits and circuit components of the device. Enclosure 14 may be of any hand-held shape desired that is functional and hand manipulable, examples of which include a PDA (as shown), mobile phone, PCMCIA card, snapshot-type camera, replica sports helmet, replica baseball bat or football, or scaled racing car.

On front surface 16 of hand-held device 12, above LCD 44 is imprinted the brand name of a sponsor 17 and possibly information or indicia that may induce a user to associate device 12 with sponsor 17. When hand-held devices 12 are inexpensive to manufacture, such as when they are in the form of smart cards, businesses are more likely to participate in distribution of hand-held devices 12 and accordingly sponsor 17 may be included on these devices 12 with higher frequency. However, when hand-held devices 12 are a user's multi-function personal device such as a mobile phone or PDA, which has a primary use other than receiving promotional opportunities, such indicia is less likely to be included. Sponsor 17 may be a company providing hand-held device 12 to a user of its service, such as a hotel, phone company, PDA service, or place of business. Sponsor 17 may provide permanent or temporary use of hand-held device 12 for access, privileges, and/or rewards. Sponsors 17 may also include various entities such as advertisers, Internet websites, television shows, as well as for organizations providing or participating with other occurrences, programs or events, for which use of hand-held device 12 will provide means for a user to obtain promotional opportunities.

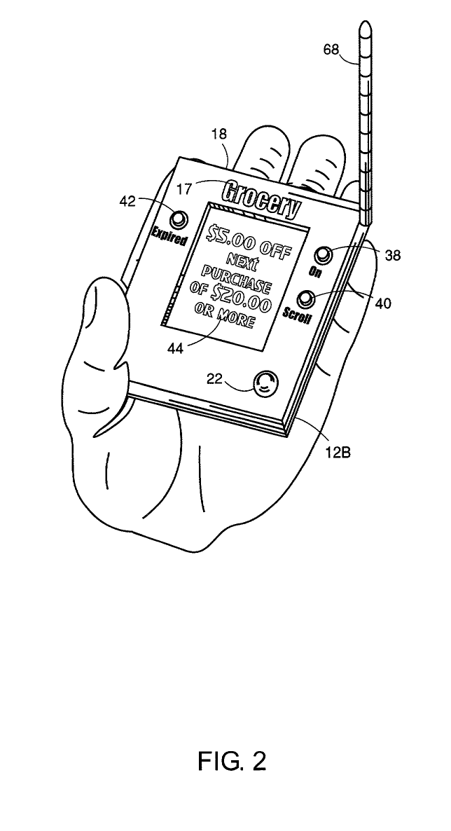

Hand-held device 12 as illustrated in FIG. 2 have both RF antennae 68 and lens 36 so that device 12 may receive auxiliary data by both optical and electrical means. When hand-held device 12 contains such reception means, it may be used with multiple promotional opportunities in multiple locations. Thus, with the present invention, a user may receive auxiliary data on hand-held device 12 at a game inside a stadium or arena electrically via RF antennae 68, and may also receive auxiliary data while watching a game at home optically by positioning leading edge 18 towards display device 10. Users may thus participate in promotional in multiple locations using the same hand-held device 12.

Button 22 of hand-held device 12 preferably provides the user with means for selecting between receiving auxiliary data via electrical means (such as through RF antenna 68) or by optical means (such as through photosensor 30). Preferably, the user, based on location, will select the means by which he/she wishes to receive the auxiliary data thereby saving power and preventing the user from receiving undesirable auxiliary data. However, handheld device 12 may be configured to monitor the data input means (e.g., RF antenna 68 and photosensor 30) to determine whether auxiliary data is being transmitted to device 12 by any of the methods described herein.

Referring now to FIG. 2, an embodiment of hand-held device 12 is shown to include LCD 44. LCD 44 is capable of presenting the graphic content in monochrome, however color is preferably used. However, LCD 44 may also be an alphanumeric “textual” display consisting of 16 digits, but less or more display capability may be provided based on usage and need.

Hand-held device 12 has power button 38 that when depressed will initiate operation of LCD 44 to display a coupon, a prize notification, or other information indicating receipt by device 12 of auxiliary data. For example, LCD 44 may used to display a first coupon in a circularly linked list of offers. Power button 38 may also held to initiate receiving audio signals, or may be used for other display or control purposes separately from button 22. Scroll button 40 allows a user to traverse, i.e. scroll, information retained or received by hand-held device 12, for example, the circularly linked list of offers received and stored on device 12. It will be appreciated in the art that any of the various buttons 22, 23 (not shown), 38, 40, or 42 may be implemented by using other “pre-existing” buttons (i.e., with other functionality) on hand-held device 12, such as the numbered buttons on a mobile phone or shortcut buttons on the PDA. It will furthermore be appreciated that these buttons 22, 23, 38, 40, or 42 may be implemented via touch screen, such that physical buttons 22, 23, 38, 40, or 42 may be implemented “virtually” on hand-held device 12. Expiration button 42 acts in the manners disclosed in Koplar. Offers received by hand-held device 12 may be indicated not just by illuminating lights 20, but by textual information and graphics displayed on LCD 44 as may be observed in FIG. 2.

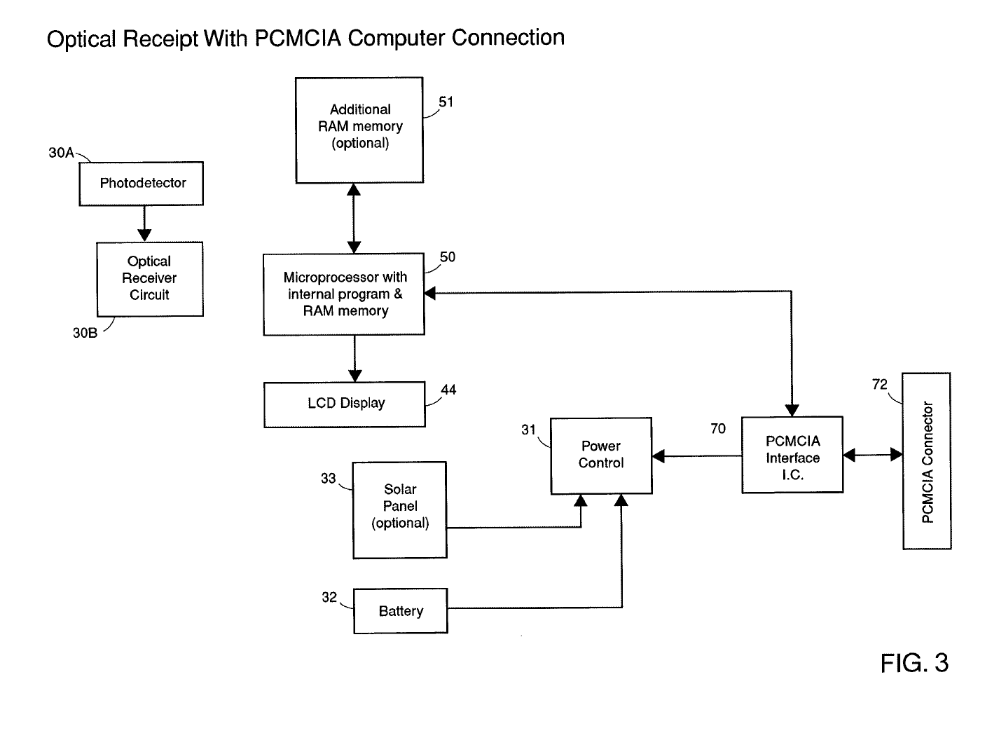

FIG. 3 shows a chart of an alternate embodiment of hand-held device 12 having an input-output means preferably in the form of a Personal Computer Memory Card International Association (“PCMCIA”) interface 70, such as may commonly be found on a laptop computer. PCMCIA interface 70 of hand-held device 12 connects with PCMCIA connector 72 of a computer or computer-like device to transmit information back and forth. Connections with PCMCIA interface 70 to a computer are preferably made by a PCMCIA port, but the connection means may also be other known computer and computer-like slots, connections, and ports such as Ethernet, Token Ring, infrared (“IR”), RF, Small Computer System Interface (“SCSI”), Universal Serial Bus (“USB”), parallel port (“Parallel”), serial port (“Serial”), IEEE 1394 FireWire (“FireWire”), S/PDIF, AES/EBU, fiber optical cable, and Apple Desktop Bus (“ADB”). Hand-held device 12 may also utilize portable data storage (not shown), such as flash memory, mini-disc, or stick memory, to hand-transfer information from handheld device 12 to a computer. The types of connections used in various applications of hand-held device 12 may vary based on factors including cost, transfer speed, acceptance by industry, and user preference. Implementations of hand-held device 12 incorporating PCMCIA interface 70 and its methods of use are disclosed in Koplar and may be interchangeably used with the present invention.

Similarly, hand-held devices 12, whether or not sized as “cards”, PDAs, or mobile phones or other conveniently hand-held size, and whether in the form of racing devices, may simulate other objects, vehicles, personalities, or devices for house-hold, personal or business use, so as to provide a verisimilitude or facsimile representation of such devices 12 or usage, so that hand-held device 12 suggests to the user the manner of its use, or conveys to the users special feeling, sense, identity or association with a field, activity, sport, entertainment or other use of the device 12 it represents. In games, for example, in which some or all of the information content useful in the game may be provided by auxiliary data, hand-held devices 12 are configured to provide a verisimilitude or facsimile representation of such devices holder 12 or usage may give players of the game enhanced sense of play, participation or gaming identity. The foregoing is merely illustrative of the many possibilities.

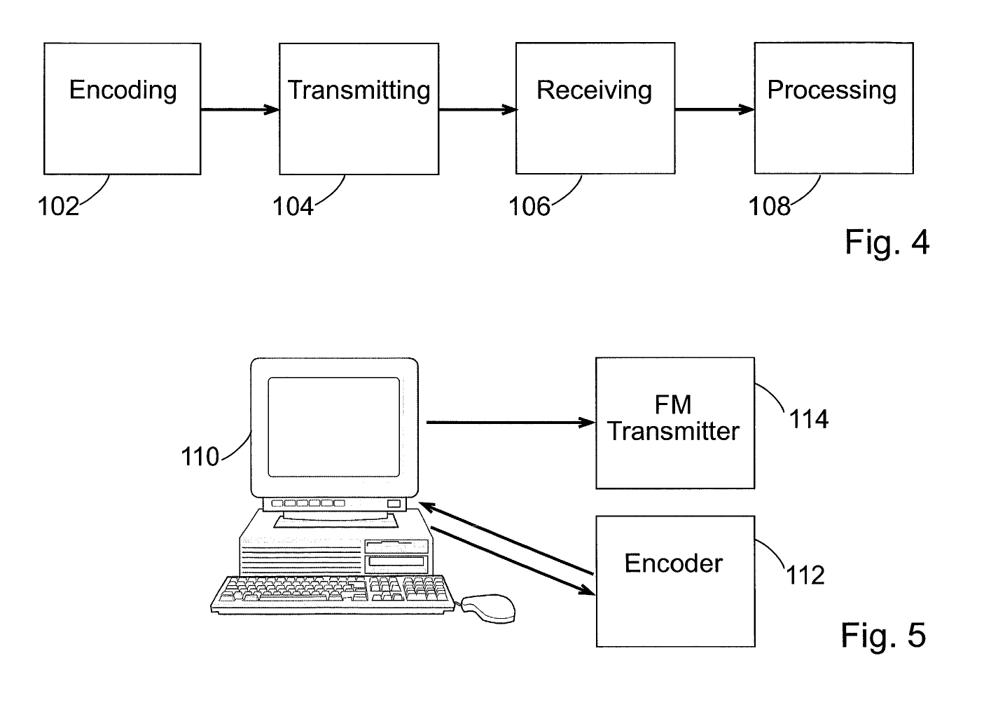

The present invention utilizes a novel method of transmitting auxiliary data to hand-held devices 12 using the existing RBDS system. This method of the present invention is shown in FIG. 4 and described herein. A first encoding step 102 comprises modulating a FM signal with date that will be transmitted within a subcarrier of the FM signal. Encoding step 102 preferably transpires at a radio station, but alternatively transpires at a location that records radio commercials.

Turning to FIG. 5, encoding step 102 may be observed in more detail. In encoding step 102, a sponsor enters a promotional opportunity (in the form of data) that it wishes to provide users into a computer 110. Computer 110 processes its input and, using RBDS encoder 112, encodes the information within a subcarrier of the FM signal. More specifically, the RBDS methodology used with the present invention impresses the information onto a 57 kHz subcarrier within a designated frequency (e.g., 94.7 mHz). Once the FM signal is modulated to contain a subcarrier with the promotional opportunity, the FM signal is ready to be transmitted by use of FM transmitter 114.

The preferred method of transmitting information via FM transmitter 114 using RBDS is through the use of an existing FM radio station (that broadcasts on a known frequency) during a prerecorded commercial. (FM transmitter 114 and FM radio station are referred to collectively hereinafter as the “RBDS signal source”.) In this way, encoding step 102 as shown in FIG. 4 may be completed in advance of a commercial's airing, such that additional radio station personnel will be unnecessary at the time of commercial transmission. Alternatively, encoding step 102 may occur such that the FM signal is modulated in real-time immediately before it is transmitted via transmitting step 104. By either method, the encoded information is preferably synchronized to whatever audio is contained with the main carrier of the FM signal. It will be appreciated in the art that the methods of triggering the inclusion of the information may be used interchangeably depending on the manner in which a sponsor desires to provide the promotional opportunity.

Referring back to FIG. 4, transmitting step 104 effectuates the transmission of the modulated FM signal after the completion of encoding step 102. The FM signal may be transmitted as is common with non-modulated FM radio wave signals as will be appreciated in the art. The FM signal is transmitted via airwaves and may be received by hand-held devices 12, as well as standard radios that are incapable of providing promotional opportunities described herein.

Appropriately tuned hand-held devices 12 during receiving step 106 may receive the FM signal as will further be described below. Once the FM signal is received by hand-held device 12, a processing step 108 occurs in which the FM signal is processed and, when information containing a promotional opportunity is present within the FM signal, a user is presented with a promotional opportunity on device 12.

When desirable, users of hand-held device 12 may receive notification of the transmission of a promotional opportunity. In the preferred embodiment, users are alerted via the audio contained with the main carrier of the FM signal. Users listening to a radio may be instructed to “hold down your button now to receive an opportunity”, or otherwise may be advised that they will soon receive or just have received a promotional opportunity on their hand-held device 12. However, under the present invention it is not necessary for a user to listen to a radio to receive promotional opportunities. Hand-held device 12, however, must be “listening” to a frequency to detect the subcarrier. Therefore, as an alternative, an alert may come directly from hand-held device 12. The users may be alerted either audibly or visually, such as may include a “beeping” or other sound, the lighting of a LED 20, shaking or other vibration of hand-held device 12, or a text message displayed on LCD 44.

The promotional opportunity may be processed by handheld device 12 via various methods including those described in Koplar I and Koplar II, depending on the money allocated to the manufacturing cost of device 12 and the application in which device 12 is to be used. In the preferred embodiment, the information received by hand-held device 12 contains all the text to be displayed to provide the user with the promotional opportunity.

Alternatively, the information sent to hand-held device 12 may be a trigger for pre-stored promotional opportunities. Once a trigger has been received and processed by hand-held device 12, the user may receive an audio or visual indication that an opportunity is forthcoming or that an opportunity has just been received by device 12.

The information received by hand-held device 12 may contain means to differentiate and categorize the promotional opportunities through use of a classification code. The classification code corresponds to a category of a promotional opportunities, such categories may be found to include apparel, automotive, computers, contests, dining, electronics, entertainment, financial services, groceries, health and beauty, home and garden, Internet websites, children, pet products and travel. The aforementioned list is an example only, and other types of categorization schemes may be used depending on the applications in which hand-held device 12 are to be used.

A stored record contains a database with flags of the user's preferences. Users identify the categories in which they wish to receive promotional opportunities. The categories may be set upon issuance of hand-held device 12, but is preferably programmed directly by the user either by connecting device 12 to a computer (via the methods of computer connection are described in Koplar I and Koplar II) to download a configuration to device 12. When a classification code is received by hand-held device 12, device 12 makes a comparison of the classification code received against the stored record to determine whether device 12 should store the promotional opportunity and alert the user, ignore the promotional opportunity, or take another action as may be designated by the sponsor (or the user). The stored record may alternatively indicate that some promotional opportunities should be immediately stored and displayed to the user, while other categories of promotional opportunities should provide the user with the ability to view, store, and/or immediately discard the received promotional opportunities. It will be appreciated in the art that this concept of promotional opportunity categorization is novel to hand-held devices 12 and may be modified and expanded to encompass known techniques for “opt-in” mailing. Thereby, users of hand-held device 12 will not have to parse numerous promotional opportunities that they are not interested in to locate the opportunities that are of value to them. It will be also appreciated that the method of promotional opportunity categorization may function outside of hand-held device 12 and may work with other types of devices.

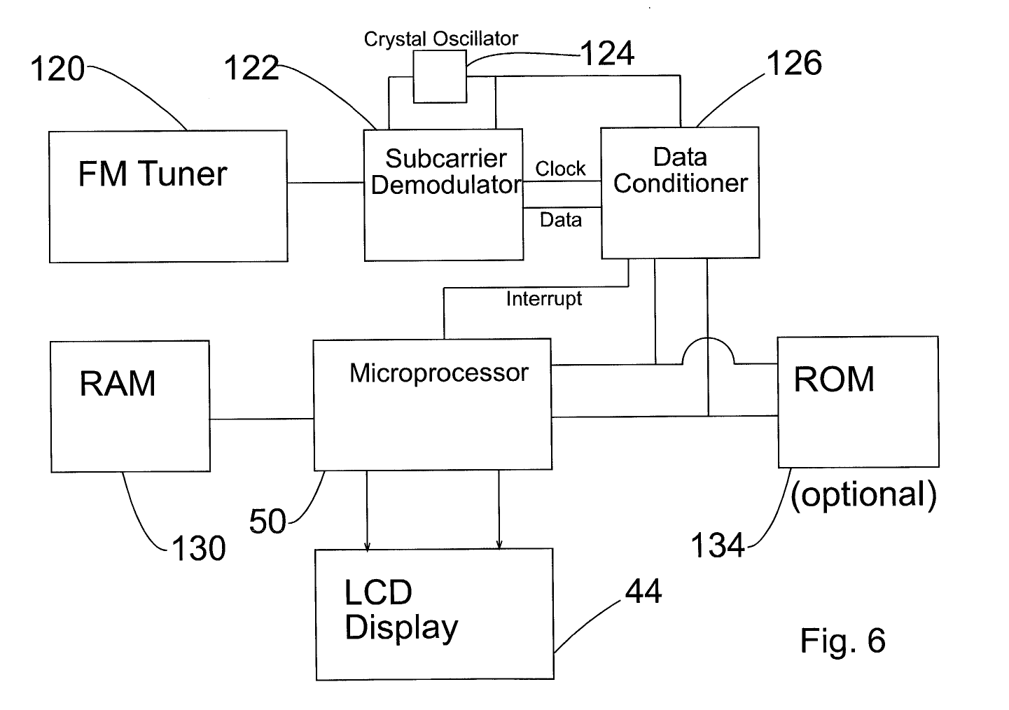

Turning now to FIG. 6, the circuitry of the hand-held device may be observed. FM tuner 120 is used in receiving step 106 (as shown in FIG. 19) to receive the FM signal on hand-held device 12. FM tuner 120 also initiates processing step 108 (as shown in FIG. 19) and preferably contains means to detect both the main carrier (which contains the audio) and the subcarrier (which contains the information). Without the detection means of the main carrier, it is impractical to make FM tuner 120 sensitive enough to identify the subcarrier.

FM tuner 120 receives the FM signal (e.g., double side band suppress carrier) containing the auxiliary data at the radio frequency specified on crystal oscillator 124. Subcarrier demodulator 122 then processes the FM signal by converting the subcarrier signal, if present, into a data stream. Thereby, the information that was originally encoded in the studio is extracted into a raw form (i.e., the data stream). The data stream, as it exists after being created by the subcarrier demodulator 122, is in such a raw form that it is virtually unusable. The data stream consists of a clock signal and data signal. The clock signal is synchronized to the clock of computer 110.

The ways in which FM tuner 120 tunes to a specific frequency depends on the application. The preferred embodiment is permanently set upon crystal oscillator 124, so that hand-held device 12 leaves the factory and remains at a constant frequency. Alternatively, FM tuner 120 may control crystal oscillator 124 such that it constantly scans radio frequencies until it locates a modulated FM signal. It then stops scanning, and determines whether the modulated FM signal is relative to the desired application. The third method is where FM tuner 120 is directly controlled by the main microprocessor 128. Microprocessor 128, with or without input from the user, may decide to scan every frequency or it may have a list of frequencies at which to look. It will be appreciated that hand-held device 12 may be configured to receive only those FM signals of a particular station, of a particular parent company, or within a particular market (e.g., St. Louis, Mo.).

The clock signal and data signal may be observed to travel from subcarrier demodulator 122 to data conditioner 126. Data conditioner 126 is configured to be compatible with computer 110, so that data conditioner 126 is capable of parsing out the transmitted information.

It will appreciated in the art that as the signal travels from FM tuner 120 to subcarrier demodulator 122, the FM signal may be received by an amplifier (not shown) so that a user may hear the audio (i.e., voices and music) contained with the FM signal.

In the preferred method of the present invention, there is no start and stop pulse transmitted along with the information. This configuration differs from computer processing on a home computer, wherein the signals contain a start pulse, 8 bits of data, and a stop pulse. On a home computer, at the receiving end of the data the computer looks for a stop pulse. However, with the preferred method of the present invention, it is undesirable to allocate time and resources to look for the start and stop pulses. Data is sent continuously without start and stop pulses and instead an error correction code is sent and used. After two bytes of data are sent, the correction code is sent. During encoding step 102, encoder 112 processed the FM signal and the algorithm was performed prior to its transmission. The computer uses its knowledge of the information to obtain the correction code. The correction code, when received by hand-held device 12 is processed by the reverse of the algorithm to determine the originally sent information. Data conditioner 126 therefore extracts the information from the data stream. Every time data conditioner 126 extracts a block of data, it comes up with a status and two data bytes. The status byte tells it which portion of the transmission it is receiving. The transmission consists of four bytes, the first of which is a status byte tells the data conditioner which block its is receiving, and the next two bytes are the actual data, and the fourth contains no data.

As soon as data conditioner 126 receives the first three blocks, it generates an interrupt pulse. The interrupt pulse alerts microprocessor so that data conditioner 26 has data and that microprocessor 50 should retrieve it. As will be understood in the art, an “interrupt” means that whatever a computer is doing prior to its receipt of the interrupt, it stops and handles the interrupt's request. When microprocessor 50 completes the task designated to it by the interrupt, it returns to its originally processing. Under the present invention, microprocessor 50 sees the interrupt and queries data conditioner 126 as to what data it has. The information transferred from data conditioner 128 to microprocessor 50 is preferably through the i-squared-c protocol, a Phillips proprietary protocol that is well known in the art.

When microprocessor 50 sees that the information is a promotional opportunity, it puts the opportunity into RAM 130. There are four blocks of data sent every time. The first block is the PI code, which contains the station identifier or network ID. The second block describes what type of information is being sent in the group of four blocks. In the preferred embodiment, it will be group 2 radio text. It may alternatively be navigation information, raw data, or other type of data that could be usable within the system of the present invention.

The second block tells the specific location within the message of the next four bytes that will be received. Microprocessor 50 stores the location information within its own internal RAM (not shown) so that it has quick access to the information. After receiving the last two blocks, microprocessor 50 knows where in RAM 30 that it needs to put the blocks. Microprocessor 50 stores the data in RAM 30 for its future use.

One of the bits sent within the second block is an AB flag. Microprocessor 50 is working on two promotional opportunities simultaneously. The first promotional opportunity is the one presently being displayed; the second promotional opportunity is the one being received. When the second promotional opportunity is complete, and the sponsor decides to send a new promotional opportunity, the AB flag changes status. The flag's change alerts microprocessor 50 that the first promotional opportunity has been sent. Microprocessor 50 then pulls the promotional opportunity out of RAM 30 and displays it on LCD display 44. While hand-held device 12 displays this promotional opportunity, the first promotional opportunity will continue to be received. The promotional opportunity will continue to be displayed received until the AB flag changes. Then hand-held device 12 displays the promotional opportunity from RAM 30, and begins to receive another new one. As it displays the promotional opportunity, it clears RAM 30 to remove artifacts of left over characters. The main processor constantly looks for the flag. This process is effective when the promotional opportunities are received and not kept, such as baseball statistics during a radio baseball game broadcast. It will be appreciated that it may be desirable to retain and reuse opportunities, and the method described herein may be altered to provide such capability.

Electronically coupled to subcarrier modulator 122 and data conditioner 126 is crystal oscillator 124. Crystal oscillator 124 is compatible with a crystal oscillator located with encoding computer 110. Crystal oscillator 124 is a precise timing mechanism that synchronizes the data coming into hand-held device 12.

ROM 134, although optional, is used in the preferred method of the present invention. ROM 134 provides an efficient means for providing a way of distinguishing between various hand-held devices 12, so that may be identifiable and, when desired, unique. By storing an ID in ROM 134, hand-held device 12 is capable of providing many of the promotional opportunities described in Koplar and herein.

Under the present invention, microprocessor 50 inserts a space in place of each character that it moved to LCD display 44. In applications of device 12 where it is desirable to retain promotional opportunities, the promotional opportunities are placed into a different place in RAM 130 while the user is reading them. Promotional opportunities are stacked until RAM 130 is filled to its capacity.

Microprocessor 50 can distinguish between the various promotional opportunities, by using time signal transmitted every minute. Microprocessor 50 may need to be equipped with a built in clock that synchs to the radio station once a minute. As the promotional opportunity is being displayed on LCD display 44 and is being saved into a higher place in RAM 130, the promotional opportunity may be time stamped. Thereby, each message has its own unique identifier, which may be used a means of archiving the promotional opportunities.

The preferable means of providing users controls under the present invention is by means of a keypad (not shown) that connects to microprocessor 50. The preferable method of configuring hand-held device 12 with a keypad is by inserting a check keypad command into the main loop of microprocessor 50, such that if the keypad is pressed microprocessor will initiate a subroutine function to handle the user request. It will be appreciated that the keypad has functionality similar to the functionality described in Koplar and herein. ROM 134 provides a means by which each hand-held device 12 may have a unique number. As information is sent, the code can be embedded within text. Use of a symbol at the beginning of a series of numbers when received by hand-held device 12 may cause the numbers not to be displayed but instead compared to the number contained with ROM 134. When a user's unit matches the number received to the number contained within ROM 134, hand-held device 12 can react in a special or unique way, to provide promotional opportunities as described in Koplar and herein.

In view of the foregoing description of the present invention and practical embodiments it will be seen that the several objects of the invention are achieved and other advantages are attained. The embodiments and examples were chosen and described in order to best explain the principles of the invention and its practical application to thereby enable others skilled in the art to best utilize the invention in various embodiments and with various modifications as are suited to the particular use contemplated.

As various modifications could be made in the constructions and methods herein described and illustrated without departing from the scope of the invention, it is intended that all matter contained in the foregoing description or shown in the accompanying drawings shall be interpreted as illustrative rather than limiting.

The breadth and scope of the present invention should not be limited by any of the above-described exemplary embodiments, but should be defined only in accordance with claims of the application and their equivalents.

The present system and hand-held devices useful in the system may be for these purposes distributed by various business entities, which may include not only the sponsor of a program, event, or other sponsored transmission, but may also include various businesses, services and organizations having commercial relationships with the sponsor. Viewer's use of the new devices of the invention accordingly provide commercially advantageous results relating to television advertising, promotions and other sponsored transmissions, wherein new system and devices and their use is effective to:

Attract viewer attention to advertising, promotions and other sponsored transmissions

Effectively increase awareness and retention of message and product Induce viewers to respond and take action after viewing to sponsored transmissions

Differentiate a sponsor's product or service from those of competitors.

Stimulate viewers to desire to watch advertising, promotions and transmissions.

Provide a novel, cost-effective, brand efficient, and enjoyable medium for enhancing advertising, promotions and other transmissions

Cause advertising, promotions and transmissions to take on special event significance

Build customer traffic in places of business or points of sale associated with sponsors of advertising, promotions and other transmissions

Increase consumer loyalty to sponsors of advertising, promotions and transmissions

Increase viewer involvement in sponsored advertising, promotions and transmissions

Cause viewer retention of sponsor identity and advertising or promotional content

Enhance sales volume resulting from the sponsorship of advertising, promotions and transmissions

Provide lasting value to sponsored advertising, promotions and transmissions

Provide enhanced viewer/spectator involvement in sporting and racing events

Afford viewers of television programming an opportunity to interact meaningfully with programming content and with advertising, promotions and transmissions.

Enhance viewer good-will relative to advertising, promotions and events.

Cause development of still other opportunities for interactive use of the devices.

1. A method of providing promotional opportunities relative to radio signals presented by a radio signal source using a RBDS encoder to a user of a hand-held device, the method characterized by:
encoding auxiliary data within a radio signal by use of the RBDS encoder;
transmitting radio signals containing auxiliary data from radio signal source;
receiving the radio signals on the hand-held device;
processing the radio signals on the hand-held device to determine whether auxiliary data is present in the radio signals;
providing the user with promotional opportunities based on the receipt of the auxiliary data by the hand-held device.

2. The method of 1 further comprising the step of providing notification to user of the hand-held device of receipt of auxiliary data by the hand-held device.

3. The method of 1 further comprising the step of providing notification to user of the hand-held device of receipt of the promotional opportunity by the hand-held device.

4. A method for predetermining the selective receipt of promotional opportunities on a hand-held device of a user, the method characterized by:
selecting by user among various categories of promotional opportunities to receive via the hand-held device of the user;
storing categorization information on the hand-held device;
receiving promotional opportunities on the hand-held device;
comparing whether the promotional opportunities received on the hand-held device match the user defined categorization information; and
selectively providing the user of the hand-held device with promotional opportunities based on the comparison of the promotional opportunities to the stored categorization information.

5. A hand-held device for receiving radio signals containing auxiliary data relating to promotional opportunities from a RBDS signal source and providing promotional opportunities to a user of the hand-held device as a result of the received auxiliary data, the hand-held device characterized by:
a radio frequency (RF) receiver disposed on the hand-held device for receiving the radio signals from the RBDS signal source; and
a central processing unit (CPU) and other circuitry disposed on the hand-held device for processing the radio signals received by the hand-held device and determining the existence of auxiliary data and promotional opportunities resulting from the received auxiliary data.

6. The hand-held device of claim 5 further comprising a visual indicator disposed on the hand-held device and coupled to the CPU for providing the user notice of the promotional opportunities available to the user by use of the hand-held device.

7. The hand-held device of claim 5 further comprising a memory disposed on the hand-held device and coupled to the CPU for storing the promotional opportunities.

8. A hand-held device for receiving promotional opportunities from a display device and a RBDS signal source, the hand-held device characterized by:
a photosensor disposed on the hand-held device for receiving the promotional opportunities directly from the display device;
a radio frequency (RF) receiver disposed on the hand-held device for receiving the promotional opportunities transmitted from the RBDS signal source;
a central processing unit (CPU) and circuitry disposed on the hand-held device for processing the promotional opportunities received by the hand-held device;
a decoding means on the hand-held device for decoding the promotional opportunities from either the display device, the RBDS signal source, or both the display device and the radio signal source; and
a memory disposed on the hand-held device and coupled to the CPU for storing the promotional opportunities.

9. The hand-held device of claim 8 is further characterized in that a display is disposed on the handheld device to present the promotional opportunities received.

10. A hand-held device for providing one or more pre-stored promotional opportunities on the hand-held device in conjunction with FM signals presented by a RBDS signal source from the reception of auxiliary data from the source to a user of the hand-held device, the hand-held device characterized by:
a radio frequency (RF) receiver disposed on the hand-held device for receiving auxiliary data from the RBDS signal source during the FM signals;
a central processing unit (CPU) and other circuitry disposed on the hand-held device which compares the auxiliary data received against pre-stored data that triggers one or more pre-stored promotional opportunity for the user of the hand-held device.
